(19) United States
(12) Patent Application Publication
(10) Pub. No.: US 2006/0101343 A1
(43) Pub. Date: May 11, 2006

(54) Image forming apparatus, display screen customization method in image forming apparatus and display screen customization program

(76) Inventor: Masahiro Machida, Ebina-shi (JP)

Correspondence Address: GAUTHIER & CONNORS, LLP, 225 FRANKLIN STREET, BOSTON, MA, 02110, US

(21) Appl. No.: 11/079,701

(22) Filed: Mar. 14, 2005

(30) Foreign Application Priority Data
Nov. 5, 2004 (JP) 2004-322757

(51) Int. Cl. G06F 3/00

(52) U.S. Cl. 715/744; 715/740

(57) ABSTRACT

A customization information processing section generates and displays a customization setting screen corresponding to a menu screen, with reference to screen design information and customization information read from respective storage sections, and then registers information regarding a button, such as a size, position, and character string input and set by a user, with the customization information storage section. When a screen display control section displays a menu screen, it generates and displays a customized menu screen based on the screen design information and the customization information read from the respective storage sections. In this manner, a standard screen provided for an image forming apparatus is customized.

### BACKGROUND OF THE INVENTION

1. Field of the Invention

The present invention relates to an image forming apparatus, and more particularly to the provision of a function of customizing a standard screen provided on an image forming apparatus.

2. Description of Related Art

Recently image forming apparatuses have grown more complex more and more additional functions and other added value have come to be attached to such machines, all in addition to standard functions such as a copy and scanner functions. For example, by providing a browser for an image forming apparatus to accept an image creation file such as an HTML (Hyper Text Markup Language) file from an external apparatus such as a server via a network, it is possible to display a screen desired by a user. Accordingly, it is possible to enhance convenience for a user, for example, by displaying on an operation panel a service button for invoking a service frequently used.

However, even when an image forming apparatus is provided with a browser, it has not been possible to customize a menu screen and the like which are provided on an image forming apparatus as a standard. Specifically, although it is possible to display a service button for invoking a service on a customization screen displayed by a browser, it has heretofore not been possible to provide, on the same level as the buttons for invoking a copy function and a scan function on a standard menu screen provided for an image forming apparatus, a service button.

### SUMMARY OF THE INVENTION

The present invention has been made in view of the above circumstances and provides an image forming apparatus in which standard screens provided therefor can be customized, a display screen customization method in an image forming apparatus, and a display screen customization program.

According to an aspect of the present invention, an image forming apparatus according to the present invention is an image forming apparatus with which one or more standard screens to be displayed on an operation panel are registered in advance, the image forming apparatus comprising a screen design information memory that stores screen design information used for displaying the standard screens on the operation panel; a customization information memory that stores customization information related to the standard screens; a display that displays a customization setting screen for inputting information used for customization of a standard screen, based on the screen design information read from the screen design information memory and the customization information read from the customization information memory; and a customization information processor that registers information input by a user from the displayed customization setting screen with the customization information memory as customization information, wherein the customization information processor enables customization of the existing standard screens of the image forming apparatus based on the customization information.

According to another aspect of the present invention, a display screen customization method is performed by a computer mounted on an image forming apparatus having an operation panel, for displaying one or more standard screens provided in advance on the operation panel, the method comprising reading screen design information used for displaying a standard screen on the operation panel and customization information related to the standard screen from a memory; displaying a customization setting screen for inputting information used for customization of the standard screen based on the screen design information and the customization information; and registering information input by a user from the displayed customization setting screen with the memory as customization information; and enabling customization of the standard screens of the image forming apparatus based on the customization information.

According to another aspect of the present invention, a display screen customization program according to the present invention causes a computer mounted on an image forming apparatus having an operation panel, for displaying one or more standard screens provided in advance on the operation panel, to function as reading screen design information used for displaying a standard screen on the operation panel and customization information related to the standard screen from a memory; displaying a customization setting screen for inputting information used for customization of the standard screen based on the screen design information and the customization information; and registering information input by a user from the displayed customization setting screen with the memory as customization information.

### BRIEF DESCRIPTION OF THE DRAWINGS

An Embodiment of the present invention will be described in detail based on the following figures, wherein:

FIG. 1 is a block diagram of an image forming system including an embodiment of an image forming apparatus according to the present invention;

FIG. 2 shows a display example of a menu screen before customization in the embodiment;

FIG. 3 shows an example of data configuration of customization information registered with a customization information storage section in the embodiment;

FIG. 4 is a flowchart showing an customization processing in the embodiment;

FIG. 5 shows a display example of a customization setting screen in the embodiment;

FIG. 6 is a flowchart showing a processing of displaying a customized screen in the embodiment; and

FIG. 7 shows a display example of a menu screen after customization in the embodiment.

### DESCRIPTION OF THE PREFERRED EMBODIMENT

The embodiment of the present invention will be now described based on the drawings.

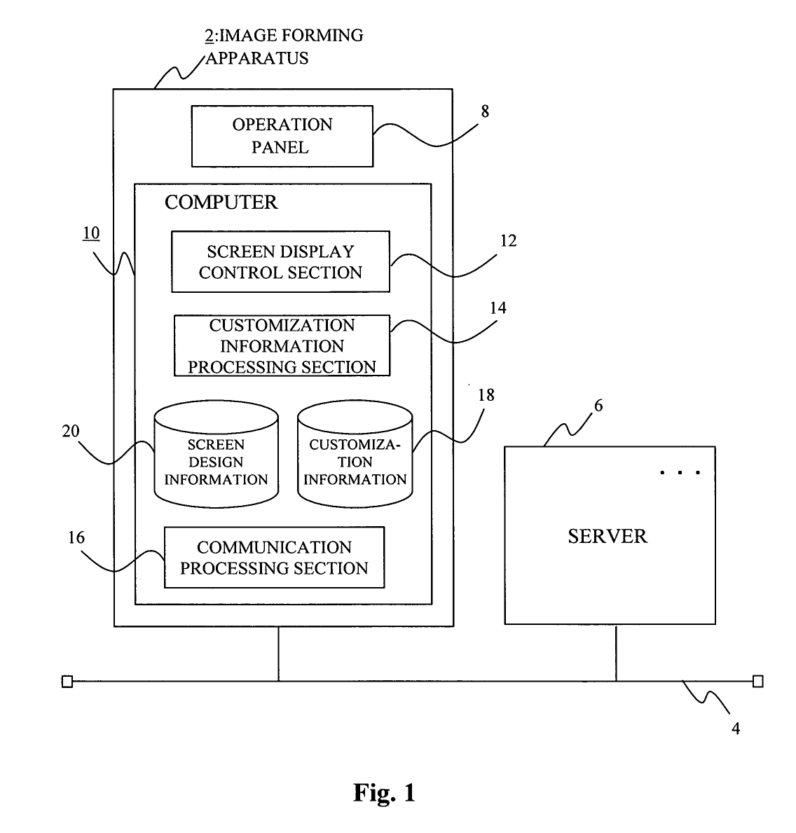

FIG. 1 is a block diagram of an image forming system including an embodiment of an image forming apparatus according to the present invention. In FIG. 1, there are shown an image forming apparatus 2 and a server 6 which performs data communication with the image forming apparatus 2 via a network 4. The network 4 maybe an intranet or the Internet.

The image forming apparatus 2 according to this embodiment is assumed to be a complex machine including at least a copy function, a scanner function, and a fax function as basic functions. A user presses a button on a menu screen displayed on an operation panel 8 of the image forming apparatus 2 to operate a desired function.

A computer 10 is provided with a screen display control section 12, a customization information processing section 14, a communication processing section 16, a customization information storage section 18, and a screen design information storage section 20. The screen display control section 12 acquires information stored in each of the storage sections 18 and 20, and performs display control such as generation and display of a screen which is originally provided for an image forming apparatus as a standard (hereinafter referred to as “a standard screen”), such as a menu screen. The customization information processing section 14 performs a customization processing such as addition of a new button to a standard screen. The communication processing section 16 performs a data communication processing with the server 6, an example of an external apparatus, via the network 4. The processing functions of the screen display control section 12, the customization information processing section 14 and the communication processing section 16 are realized by an operation performed by the computer 10 and software for realizing the processing functions in cooperation with each other.

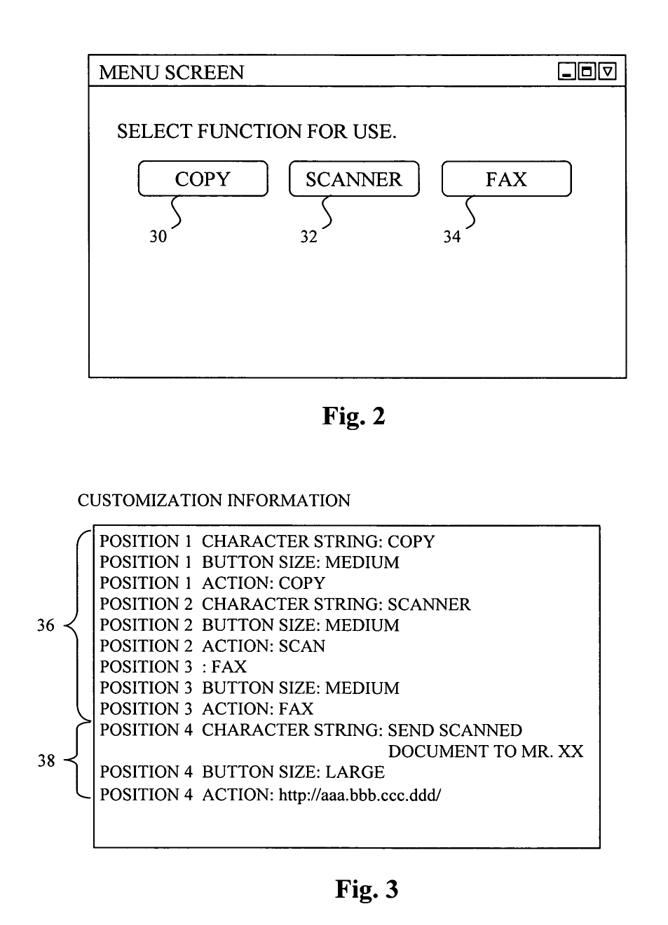

FIG. 2 shows a display example of a menu screen according to this embodiment, and FIG. 3 shows an example of data configuration of customization information registered with the customization information storage section 18 in this embodiment. A group of records 36 in the customization information is customization information corresponding to buttons 30, 32, and 34 included in the menu screen shown in FIG. 2. In the example of this embodiment, the display positions of the buttons are arranged from the upper left to the upper right, and information about a character string, the button size and an action is set for each of the positions.

To explain the screen design information registered with the screen design information storage section 20 with regard to a standard screen, for example, a menu screen, the screen design information is accumulated information other than the customization information used for displaying the menu screen. For example, layout information, such as arrangement of display positions of buttons on a screen which has been described above, information as to which button at which position is customizable and information as to the parts used for construction of a screen (regions, images, texts, fonts, and the like) are accumulated as the screen design information.

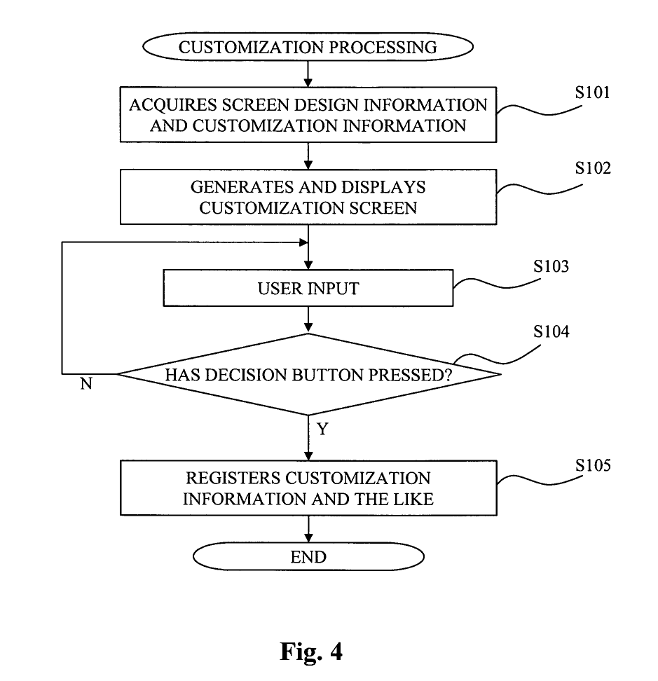

An example of operation according this embodiment will be now described. In this embodiment, the processing mainly includes a customization processing of adding a new button and a display processing of displaying a customized screen. First, the customization processing in this embodiment will be described with the use of a flowchart shown in FIG. 4.

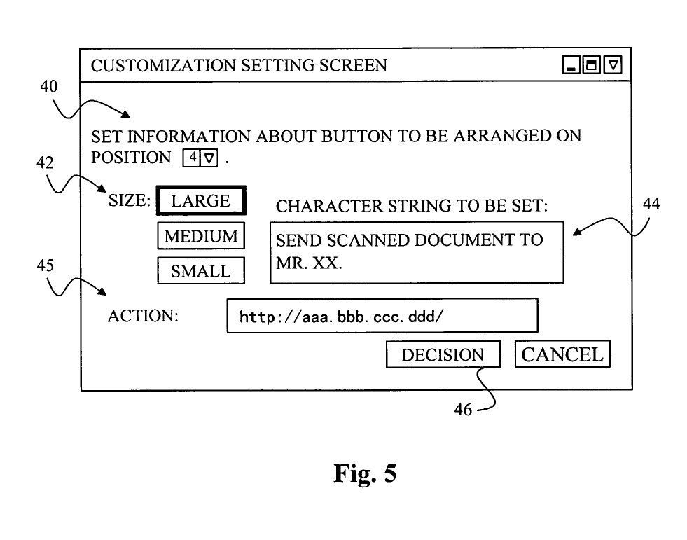

First, when a user selects the menu screen from a list of standard screens (not shown) displayed on the operation panel 8 in order to add a new button to the menu screen, the customization information processing section 14 reads screen design information and customization information from the storage sections 18 and 20, respectively (step 101). Then, by identifying which position is customizable with reference to the screen design information and acquiring content of the current settings (in this example, the group of records 36) from the customization information, the customization information processing section 14 generates and displays a customization setting screen corresponding to the menu screen selected by the user (step 102). FIG. 5 shows an example of the customization setting screen. In the example of this embodiment, for simplification of description, it is assumed that the position of a button to be newly added to the menu screen, the button size, a character string to be displayed on the button when the button is displayed on the screen, and an action to be performed when the button is pressed can be set from this customization setting screen. The user then selects a position where customization is to be performed by the user, from a combo box 40. The customization information processing section 14 reads a position where customization is possible, from the screen design information and determines the position number to be displayed on the combo box 40. After selecting a customization position, the user selects any of buttons (large, medium, small) 42 for setting the button size for the selected position, and inputs a character string to be displayed on the button, in an input field 44. Furthermore, the user inputs an action to be performed when the set button is pressed, in an input field 45.

After inputting and setting by the user (step 103), when a decision button 46 is pressed (step 104), the customization information processing section 14 registers the content set by the user with the customization information storage section 18 (step 105). For example, if the settings input by the user call for a button to be displayed at the fourth position, with the button size of “large”, and with the character string “send scanned document to Mr. XX” displayed thereon, and that the URL of “http://aaa.bbb.ccc.ddd/” is accessed when the button is pressed, as illustrated in FIG. 5, then a group of records 38 is newly added as customization information as shown in FIG. 3.

In the above description, the user inputs and specifies in the input field 45 a URL to be accessed when the button is pressed as an action. However, the specification is not limited to a URL, and a name of an existing service (function), such as “copy”, may be also specified, as illustrated in the group of records 36. The description of an action corresponding to a button actually pressed by the user is interpreted by an image forming processing section (not shown) mounted on the computer 10 for performing an image forming processing. For example, if the description of an action indicates an URL, then the URL is accessed, and if it is a name of an existing service, then execution of the described existing function is started.

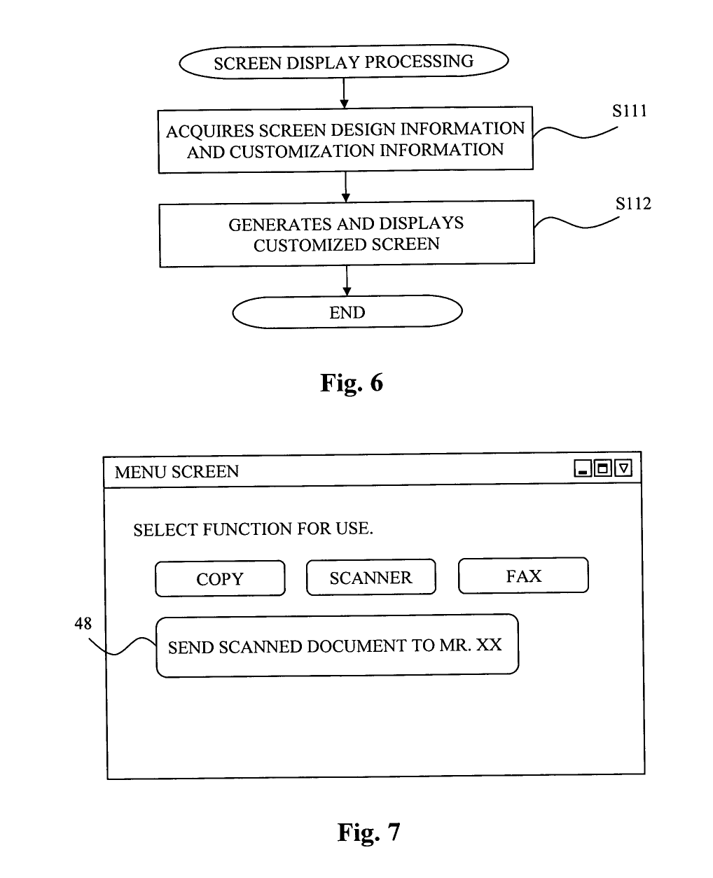

A processing of displaying a customized screen in this embodiment will be described with the use of the flowchart shown in FIG. 6.

When the screen display control section 12 displays a menu screen, it reads screen design information and customization information from the storage sections 18 and 20, respectively (step 111). Then, the screen display control section 12 generates a main part of the menu screen with reference to the screen design information, generates a button in a manner that it is displayed with a specified size and with a specified character string shown thereon, with reference to the customization information, and arranges the generated button at a predetermined position on the menu screen. The screen display control section 12 displays the menu screen generated in this way on the operation panel 8 (step 112). FIG. 7 shows a display example of this menu screen. As apparent from comparison of FIG. 2 and FIG. 7, a button which has been newly registered through the customization processing described above is added and displayed.

According to this embodiment, information used for generation and display of standard screens is retained and managed by storage means, and a standard screen is generated and displayed with the use of the information, and thereby it is possible to easily add a button to a standard screen. That is, it is possible to add a button generated by user customization (a service button) to a standard screen of the image forming apparatus 2 at the same level as buttons provided as a standard (standard buttons) such as a copy button. Therefore, the user can execute a desired function (in this example, sending of a scanned document to Mr. XX) only by pressing the service button without activating a browser or the like.

Although in the example used to illustrate this embodiment, the position, size, and character string of a button are set as customization information for generating a service button, the customization information is not limited thereto. For example, font and character color may also be customizable. In this embodiment, the screen design information and the customization information are exclusive of each other, and a customized standard screen is generated and displayed by combining information. Accordingly, although a font is included in the screen design information in the above description, information about a font must be removed from the screen design information and included in the customization information if the font is to be customized. Of course, it is not necessarily required that the two kinds of information should be exclusive of each other, and it is possible that, if the same information is included in both of the screen design information and the customization information, the information included in the customization information is to be processed prior to the information included in the screen design information. In this case, an input area for setting a font is provided in the customization setting screen shown in FIG. 5, and information about the set font is registered in association with a position in the customization information shown in FIG. 3.

In the example used to illustrate this embodiment, a position at which a service button is to be added is identified by a position number in advance and a button size is set from three sizes. However, if the screen is managed with coordinate data, a service button can be generated and displayed at any position and with any size.

Although n the example used to illustrate this embodiment, a case has been described wherein a service button is added to a standard screen as an example of customization, in addition to a button, various information used for display of a screen, such as screen color and layout, may be customizable.

Although a menu screen was described as an example of a standard screen in the explanation of this embodiment, this embodiment is applicable to other standard screens, such as, for example, a screen for a copy function. Furthermore, if the screen design information and the customization information are managed with identification numbers of standard screens and the like, customization can be performed for multiple standard screens. Furthermore, by managing the customization information in association with user identification information (user login IDs) or the like, it is also possible to construct a standard screen customized for each user.

The entire disclosure of Japanese Patent Application No. 2004-322757 including specification, claims, drawings and abstract is incorporated herein by reference in its entirety.

What is claimed is:

1. An image forming apparatus with which one or more standard screens to be displayed on an operation panel are registered in advance, the image forming apparatus comprising:
a screen design information memory that stores screen design information used for displaying the standard screens on the operation panel;
a customization information memory that stores customization information related to the standard screens;
a display that displays a customization setting screen for inputting information used for customization of a standard screen, based on the screen design information read from the screen design information memory and the customization information read from the customization information memory; and
a customization information processor that registers information input by a user from the displayed customization setting screen with the customization information memory as customization information,
wherein the customization information processor enables customization of the existing standard screens of the image forming apparatus based on the customization information.

2. The image forming apparatus according to claim 1, further comprising:
a screen display controller that reads the screen design information and the customization information from the memories, respectively, and combines the screen design information and the customization information to generate a standard screen.

3. The image forming apparatus according to claim 1, wherein
the customization information is information related to a button to be added to a standard screen.

4. A display screen customization method to be performed by a computer mounted on an image forming apparatus having an operation panel, for displaying one or more standard screens provided in advance on the operation panel, the method comprising:
reading screen design information used for displaying a standard screen on the operation panel and customization information related to the standard screen from a memory;
displaying a customization setting screen for inputting information used for customization of the standard screen based on the screen design information and the customization information; and
registering information input by a user from the displayed customization setting screen with the memory as customization information; and
enabling customization of the standard screens of the image forming apparatus based on the customization information.

5. The display screen customization method in an image forming apparatus, according to claim 4, further comprising:
reading the screen design information and the customization information from the memory; and
generating a customized standard screenby combining the screen design information and the customization information.

6. A display screen customization program for causing a computer mounted on an image forming apparatus having an operation panel, for displaying one or more standard screens provided in advance on the operation panel, to function as:
reading screen design information used for displaying a standard screen on the operation panel and customization information related to the standard screen from a memory;
displaying a customization setting screen for inputting information used for customization of the standard screen based on the screen design information and the customization information; and
registering information input by a user from the displayed customization setting screen with the memory as customization information.

7. The display screen customization program according to claim 6, the program causing the computer to function as:
reading the screen design information and the customization information from the memory; and
generating a customized standard screen by combining the screen design information and the customization information.
